(19) United States
(12) Patent Application Publication
(10) Pub. No.: US 2011/0155792 A1
(43) Pub. Date: Jun. 30, 2011

(54) Method and apparatus for scoring or skiving a solder dam

(76) Inventor: James V. Russell, Whitehouse Station, NJ (US)

(21) Appl. No.: 12/798,216

(22) Filed: Mar. 31, 2010

Related U.S. Application Data
(60) Provisional application No. 61/284,979, filed on Dec. 30, 2009.

(51) Int. Cl. B23K 31/02; B23K 37/00; B23K 26/38

(52) U.S. Cl. 228/165; 228/15.1

(57) ABSTRACT

The present disclosure provides for scoring a line on metal to form a solder dam to define a solderable area on a metal surface. The solderable area can define solderable pads on a solid copper plane or at the end point of a trace on a circuit board. The present disclosure provides for soldering metallic surfaces together and for aligning solderable objects to one another. The surface tension of solder enables the parts to be aligned through the manipulations of the skived patterns and their placement. The skiving can be done either by laser skiving or by mechanical scoring on the metallic surfaces.

### RELATED APPLICATIONS

This is a non provisional application of a provisional application Ser. No. 61/284,979 by James V. Russell filed Dec. 30, 2009.

### BACKGROUND

### Field

The present disclosure relates to a method and system for aligning soldering objects together. In particular, the present disclosure relates to a method and system for scoring a line on a metallic object for defining solder pads or areas on a metallic plane such as but not limited to copper plane or on an end point of a trace circuit board. The present disclosure provides for soldering two metallic surface together and aligning solderable objects to one another by the manipulation of the skived patterns and by their placement.

### SUMMARY

A method and system for scoring a line on metal to form a solder dam to define a solderable area on a metal surface. The solderable area can define solderable pads on a solid copper plane or at the end point of a trace on a circuit board. The method and system of the present disclosure provides for soldering metallic surfaces together and for aligning solderable objects to one another. The surface tension of solder enables the parts to be aligned through the manipulations of the skived patterns and their placement. The skiving can be done either by laser skiving or by mechanical scoring on the metallic surfaces. The creation of these dams prevents solder from overflowing onto the circuit boards and makes for easier placement and configuration of the objects placed together.

### BRIEF DESCRIPTION OF THE DRAWINGS

FIG. 1 shows a skive line formed at the end point of a trace in accordance with the present disclosure;

FIG. 2 shows solder pads defined by skives on two copper planes that are being aligned in accordance with the present disclosure.

### DETAILED DESCRIPTION OF THE PREFERRED EMBODIMENT(S)

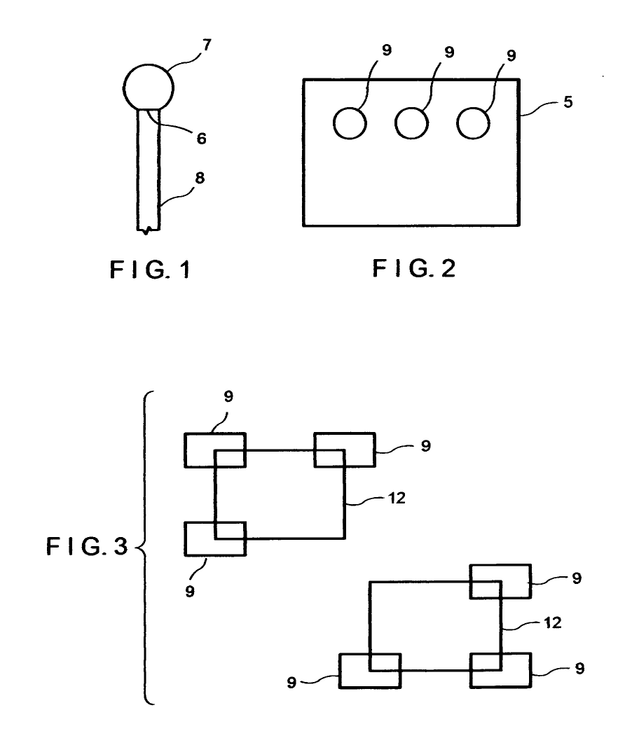

Referring now the drawings of FIGS. 1-2, FIG. 1 illustrates the formation of a skived dam on a metallic surface for preferably a circuit board 5 (FIG. 2) such as but not limited to a copper plane where a skive line 6 can be formed such as at the end 7 of a trace 8 (FIG. 1).

In FIG. 2 the skived pattern 9 is shown on a plane such as a copper plane for a circuit board 5. In FIGS. 1 and 2 the skived or scored line or pattern, respectively, can be formed by either laser skiving or mechanically scoring through use of lasers or conventionally known mechanical scoring techniques. In this way, a solder dam can be provided by forming a solder dam in the form of a line at the end of a trace (FIG. 1) or in patterns of a metallic plane (FIG. 2). This makes it easier to align metallic pieces together by manipulating and arranging for placement of these pieces together so that the solderable objects are placed next to each other.

As shown in FIG. 3 the metallic objects or parts 12 with scored or skived lines (not shown) or scored or skived patterns 9 (shown) can be aligned next to each other using this technique of the present disclosure. The surface tension of solder enables the parts 12 to be aligned through manipulation of their skived or scored patterns and by their placement next to each other as shown in FIG. 3.

Thus, while the preferred embodiment for practicing the present invention has been described in detail, it will be apparent that various modifications or alterations may be made therein without departing from the spirit and scope of the invention.

1. A method for forming a solder dam, the steps comprising:
scoring or skiving a line on a metallic surface to define a solderable area on the metal surface wherein said solderable area defines solderable pads on a solid copper plane or an end point of a trace on a circuit board.

2. The method according to claim 1 wherein more than one of said metallic surfaces are soldered together for aligning solderable objects to one another and containing the solder to a specific location.

3. The method according to claim 2 wherein a surface tension of solder enables the said solderable objects to be aligned through the manipulations of the scored patterns and their placement.

4. The method according to claim 1 wherein said skiving can be done either by laser skiving or by mechanical scoring on the metallic surfaces.

5. (canceled)

6. (canceled)

7. (canceled)

8. (canceled)

9. (canceled)
